(19) United States
(12) Patent Application Publication
(10) Pub. No.: US 2009/0034257 A1
(43) Pub. Date: Feb. 5, 2009

(54) HIGH-POWER LIGHT EMITTING DIODE (LED) STREET LAMP AND BODY FRAME THEREOF

(75) Inventors: Xue-yong Liu, Yuyao (CN); Hong-xian Lou, Yuyao (CN)

Correspondence Address: AUSTIN RAPP & HARDMAN, 15 WEST SOUTH TEMPLE, SUITE 900, SALT LAKE CITY, UT, 84101, US

(73) Assignee: Xinan Street Industrial, Yuyao (CN)

(21) Appl. No.: 12/135,022

(22) Filed: Jun. 6, 2008

(30) Foreign Application Priority Data
Jul. 31, 2007 (CN) 200710044400.2

(51) Int. Cl. F21S 13/14

(52) U.S. Cl. 362/252

(57) ABSTRACT

A high-power light emitting diode (LED) street lamp includes a body frame, a plurality of light emitting diode (LED) modules, and a base unit convexly positioned on the body frame along the light emission direction of the high-power light emitting diode (LED) street lamp. The light emitting diode (LED) modules have a plurality of light emitting diodes (LEDs), and at least one circuit board. The light emitting diodes (LEDs) are electrically connected to the at lease one circuit board. The base unit has a plurality of supporting surfaces which support the light emitting diode (LED) modules. The supporting surfaces are symmetrically positioned on a normal direction of an end surface of the base unit, and the light emitting diode (LED) modules are positioned on the adjacent supporting surfaces, respectively. The supporting surfaces further comprise a plurality of edge supporting surfaces positioned on the edges of the base unit. An angle formed by the light emission direction of the light emitting diodes (LEDs) on the edge supporting surfaces and the normal direction of the end surface of the base unit is in a range between 45 degrees to 60 degrees.

### FIELD OF THE INVENTION

The present invention relates to a light emitting diode (LED) in an illumination technology field, and more particularly, to a high-power light emitting diode (LED) used in the street lamps.

### BACKGROUND OF THE INVENTION

With the development and the maturity of the light emitting diode (LED) technology, the luminescence efficiency of light emitting diode (LED) increases day by day. Current, the white light emitting diode (LED) has even achieved luminous efficiency surpassing the common incandescent lights, and the luminous flux has also increased highly. All above-mentioned qualities make light emitting diode (LED) a wide use in applications in the field of illumination. Comparing to the energy-saving lights utilizing general photovoltaic powers, light emitting diode (LED) light sources have advantages of long life, low heating, difficult to be damaged, low power consumption, and more energy-saving. People praise light emitting diode (LED) as the fourth generation light source which substitutes for fluorescent lights and incandescent lights in the 21st century.

At present, there is a type of product on the market called a high-power light emitting diode (LED) street lamp, and this product is made-up of light emitting diode (LED) light sources which substitute for traditional light sources in traditional street lamps; furthermore, some products perform simple optical process more and better than prior art of traditional light sources. However, the simple substitution and the simple process in the traditional high-power street lamps cannot achieve requirements of light distribution standards and road illumination. Thus the products cannot really be applied to the road illumination. A brand-new high-power light emitting diode (LED) street lamp based on market requirements is needed.

### SUMMARY OF THE INVENTION

The present invention sets forth a high-power light emitting diode (LED) street lamp and a body frame thereof, and solves the problems of prior art street lamps by overcoming the defects in the prior art. The high-power light emitting diode (LED) street lamp is provided with good effects of light distribution and various parameters to achieve the requirements of road illumination more easily.

The present invention is implemented as presented below. A high-power light emitting diode (LED) street lamp includes a body frame, a plurality of light emitting diode (LED) modules, and a base unit convexly positioned on the body frame along the light emission direction of the high-power light emitting diode (LED) street lamp. The light emitting diode (LED) modules have a plurality of light emitting diodes (LEDs), and at least one circuit board. The light emitting diodes (LEDs) are electrically connected to the at lease one circuit board. The base limit has a plurality of supporting surfaces which support the light emitting diode (LED) modules. The supporting surfaces are symmetrically positioned on a normal direction of an end surface of the base unit, and the light emitting diode (LED) modules are positioned on the adjacent supporting surfaces, respectively. The supporting surfaces further comprise a plurality of edge supporting surfaces positioned on the edges of the base unit. An angle formed by the light emission direction of the light emitting diodes (LEDs) on the edge supporting surfaces and the normal direction of the end surface of the base unit is in a range between 45 degrees to 60 degrees.

The supporting surfaces of the base unit further include a plurality of first supporting surfaces adjacent to the normal direction of the end surface of the base unit. An angle formed by the light emission direction of the light emitting diodes (LEDs) on the first supporting surfaces and the normal direction of the end surface of the base unit is in a range between 5 degrees to 15 degrees.

A plurality of second supporting surfaces are adjacent to the first supporting surfaces. One side of the second supporting surfaces is next to the first supporting surfaces, and the other side is next to the edge supporting surfaces. An angle formed by the light emission direction of the light emitting diodes (LEDs) on the second supporting surfaces and the normal direction of the end surface of the base unit is in a range between 35 degrees to 40 degrees.

The angle formed by the light emission direction of the light emitting diodes (LEDs) on the edge supporting surfaces and the normal direction of the end surface of the base unit is 48 degrees. The angle formed by the light emission direction of the light emitting diodes (LEDs) on the first supporting surfaces and the normal direction of the end surface of the base unit is 9 degrees. The angle formed by the light emission direction of the light emitting diodes (LEDs) on the second supporting surfaces and the normal direction of the end surface of the base unit is 36 degrees.

The first supporting surfaces are planar shape, and the second supporting surfaces and the edge supporting surfaces are outward protruded and arc-shaped configurations.

A spatial location relation of a whole light emitting diode (LED) structure formed by the light emitting diode (LED) modules on the base unit corresponds to a spatial location relation formed by the supporting surfaces of the base unit.

The base unit and the body frame are integrated into one-piece by protruding the base unit from a bottom wall of the body frame upwardly. The light emitting diode (LED) modules are positioned on one side of the base unit. A plurality of heat sinks are positioned on the other side of the base unit and extend from the bottom wall of the body frame to an opposite direction of the base unit which protrudes from the bottom wall of the body frame.

A body frame of a high-power light emitting diode (LED) street lamp includes a base unit convexly positioned on the body along the light emission direction of the high-power light emitting diode (LED) street lamp. The base unit has a plurality of supporting surfaces for supporting a plurality of light emitting diode (LED) modules, and the supporting surfaces are symmetrically positioned on a normal direction of an end surface of the base unit. The light emitting diode (LED) modules are positioned on the adjacent supporting surfaces, respectively. The supporting surfaces further comprise a plurality of edge supporting surfaces positioned on the edges of the base unit. An angle formed by the light emission of the light emitting diode (LED) modules on the edge supporting surfaces and the normal direction of the end surface of the base unit is in a range between 45 degrees to 60 degrees.

The supporting surfaces further comprise a plurality of first supporting surfaces adjacent to the normal direction of the end surface of the base unit. An angle formed by the light emission direction of the light emitting diodes (LED) modules on the first supporting surfaces and the normal direction of the end surface of the base unit is in a range between 5 degrees to 15 degrees.

The supporting surfaces further comprise a plurality of second supporting surfaces adjacent to the first supporting surfaces. One side of the second supporting surfaces is next to the first supporting surfaces, and the other side is next to the edge supporting surfaces. An angle formed by the light emission direction of the light emitting diode (LED) modules on the second supporting surfaces and the normal direction of the end surface of the base unit is in a range between 35 degrees to 40 degrees.

Compared with the prior art, the present invention ensures that while the angle formed by the light emission direction of the light emitting diodes (LEDs) on the edge supporting surfaces and the normal direction of the end surface of the base unit is in a range between 45 degrees to 60 degrees, the light emitting diode (LED) modules in the high-power light emitting diode (LED) street lamp are convexly positioned along the light emission direction of the high-power light emitting diode (LED) street lamp. Thus, the various parameters of the high-power light emitting diode (LED) street lamp achieve the requirements of road illumination more easily. The invention of the high-power light emitting diode (LED) street lamps is capable of replacing the traditional street lamps.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, where:

FIG. 1 is a three-dimensional portfolio diagram of a high-power light emitting diode (LED) street lamp according to one embodiment of the present invention.

FIG. 2 is a three-dimensional detachment diagram of a high-power light emitting diode (LED) street lamp according to one embodiment of the present invention.

FIG. 3 is a three-dimensional diagram of a lower body frame in a high-power light emitting diode (LED) street lamp according to one embodiment of the present invention.

FIG. 4 is a front view diagram of a lower body frame in a high-power light emitting diode (LED) street lamp according to one embodiment of the present invention.

FIG. 5 is a cutaway diagram of a of a lower body frame in a high-power light emitting diode (LED) street lamp according to one embodiment of the present invention.

FIG. 6 is a three-dimensional diagram of light emitting diode (LED) modules configured on a lower body frame according to one embodiment of the present invention.

FIG. 7 is a front view diagram of light emitting diode (LED) modules configured on a lower body frame according to one embodiment of the present invention.

FIG. 8 is a back view diagram of a high-power light emitting diode (LED) street lamp according to one embodiment of the present invention.

FIG. 9 is a top view diagram of a high-power light emitting diode (LED) street lamp according to one embodiment of the present invention.

### DETAILED DESCRIPTION OF THE PREFERRED EMBODIMENTS

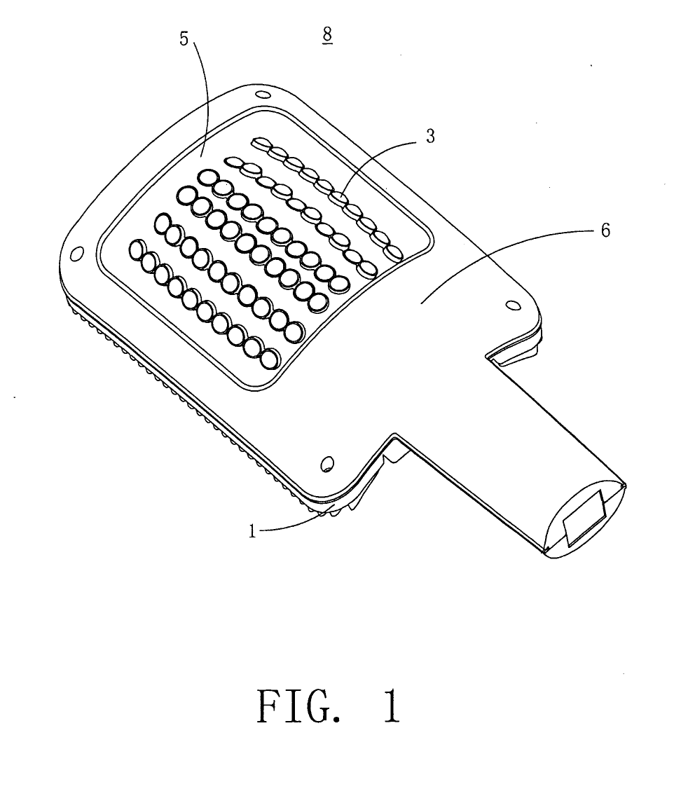

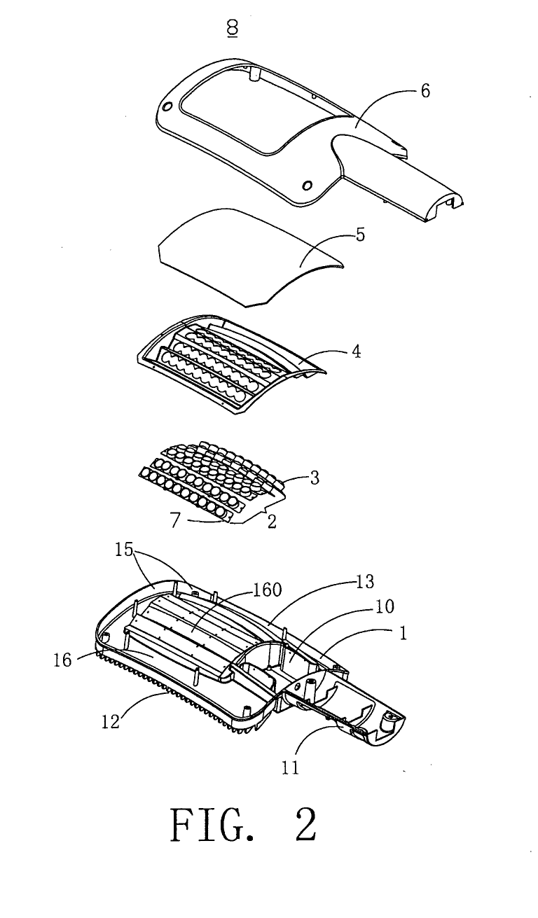

Please refer to FIG. 1 and FIG. 2. The present invention sets forth a high-power light emitting diode (LED) street lamp 8 and a body frame thereof. The high-power light emitting diode (LED) street lamp 8 includes a lower body frame 1, a plurality of light emitting diode (LED) modules 7, a reflecting device 4, a light-transmitting board 5, and an upper body frame 6. The light emitting diode (LED) modules 7 have a plurality of light emitting diodes (LEDs), a plurality of lens devices, and at least one circuit board 2. The lens devices are configured to the light emitting diodes (LEDs) correspondingly to be served as a plurality of light emitting diode (LED) lens devices 3, and the light emitting diode (LED) lens devices 3 are electrically connected to the at least one circuit board 2 to be served as the light emitting diode (LED) modules 7. The light emitting diode (LED) modules 7 are positioned in the lower body frame 1 and positioned adjacently on a base unit 160 wherein the base unit 160 is positioned within the high-power light emitting diode (LED) street lamp 8. The upper body frame 6 is fixed on the lower body frame 1 by fastening device, such as screws. The light-transmitting board 5 is fixed on the window location of the upper body frame 6.

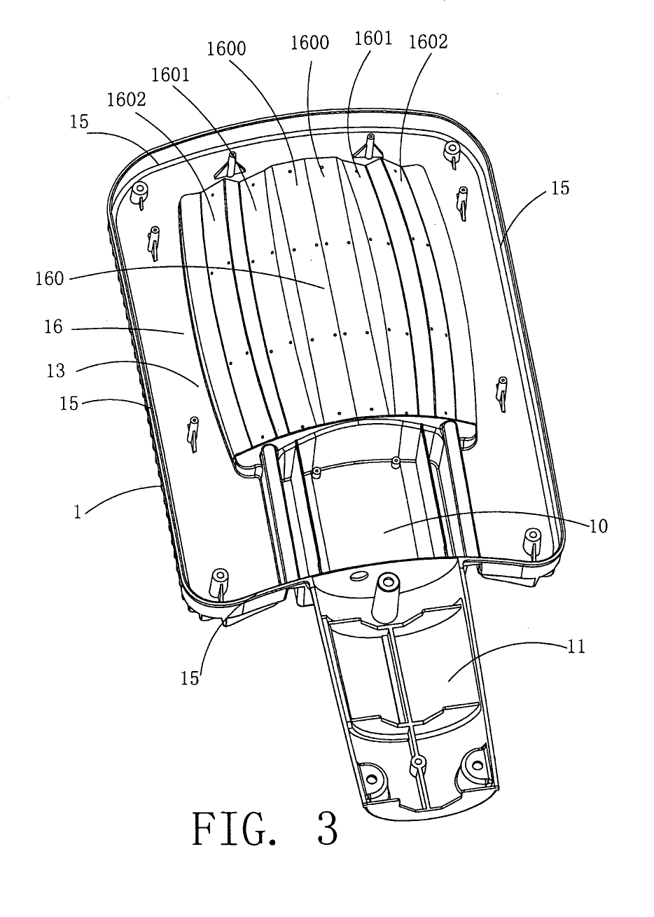

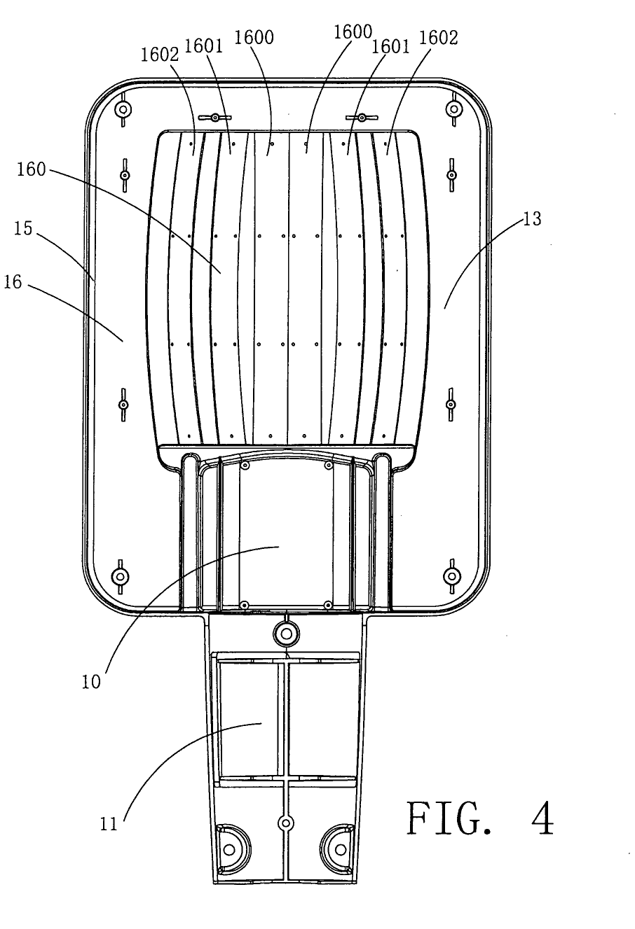

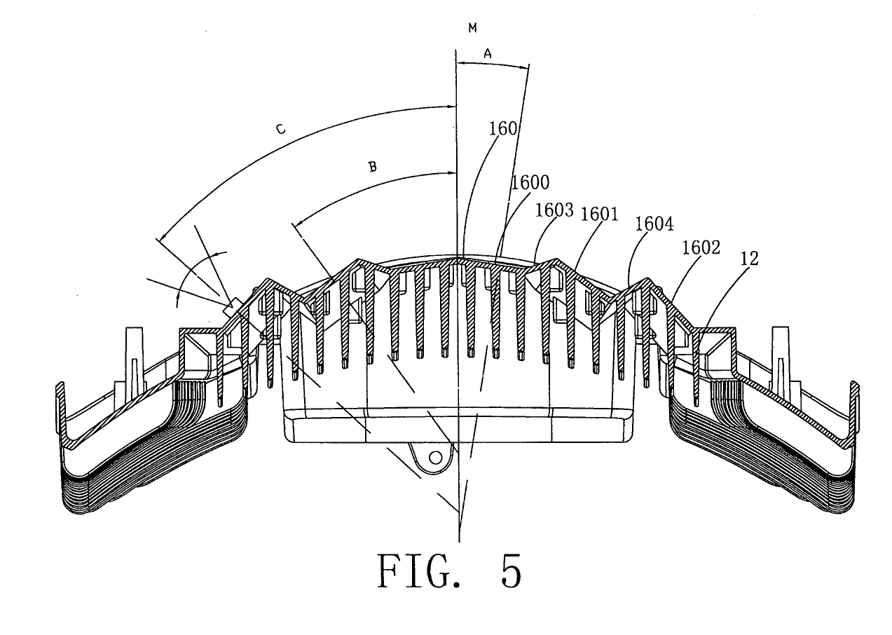

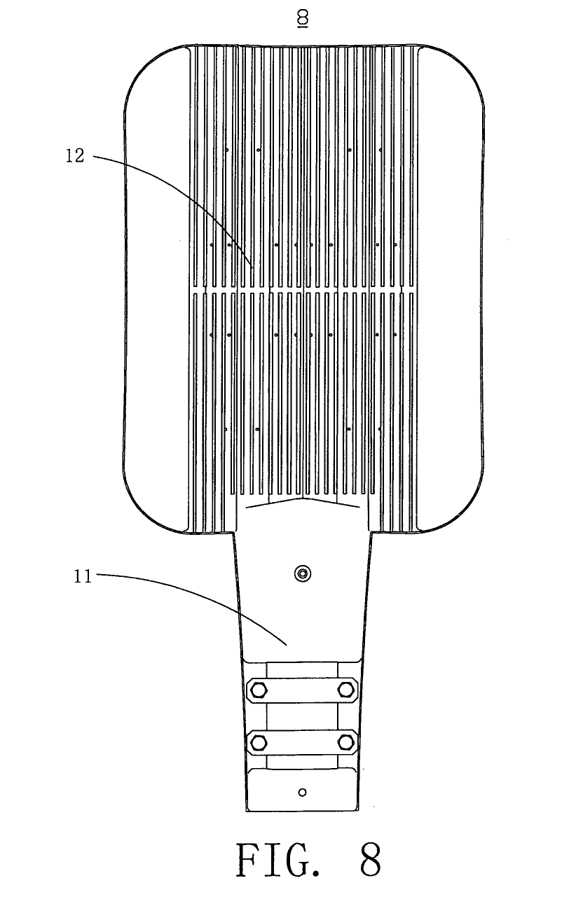

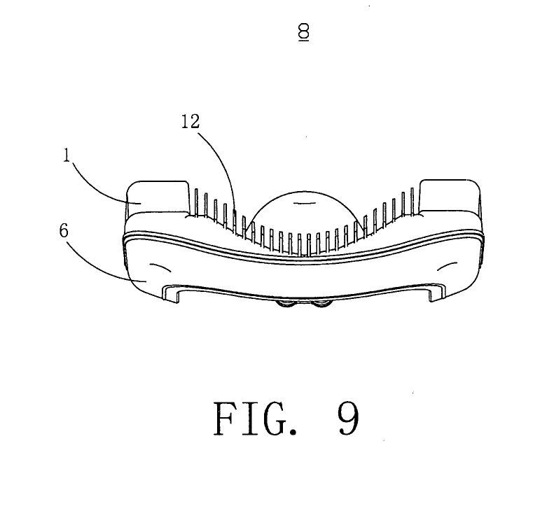

Please refer to FIG. 3, FIG. 4, FIG. 5, FIG. 8, and FIG. 9. The lower body frame 1 is made up of material which have good thermal conductivity (such as aluminum alloy or magnesium alloy). The lower body frame 1 includes a bottom wall 16, four side walls 15, and a containing space 13 which is enclosed by the bottom wall 16 and the four side walls 15. The base unit 160 is convexly positioned on the lower body frame 1 along the light emission direction of the high-power light emitting diode (LED) street lamp 8. In the embodiment, the base unit 160 and the lower body frame 1 are integrated into one-piece configuration by protruding the base unit 160 from the bottom wall 16 of the lower body frame 1 upwardly. In another case, the base unit 160 can also be shaped separately, and then fixed on the lower body frame 1 for conducting the thermal energy from the base unit 160 to the lower body frame 1. The light emitting diode (LED) modules 7 are positioned on one side of the base unit 160. A plurality of heat sinks 12 are positioned on the other side of the base unit 160 and extend from the bottom wall 16 of the lower body frame 1 to an opposite direction of the base unit 160 which protrudes from the bottom wall 16 of the lower body frame 1. The base unit 160 has a plurality of supporting surfaces which support the light emitting diode (LED) modules 7. There are six supporting surfaces in the embodiment. The six supporting surfaces are symmetrically positioned on a normal direction of an end surface of the base unit 160. The six supporting surfaces are first supporting surfaces 1600, second supporting surfaces 1601, and edge supporting surfaces 1602 from the normal direction of the end surface of the base unit 160 to the two sides of the base unit 160, respectively. For example, the first supporting surfaces 1600 adjacent to the normal direction of the end surface of the base unit 160 are planar shape, and the second supporting surfaces 1601 and the edge supporting surfaces 1602 are outward protruded and arc-shaped configurations. An acute angle is formed by the light emission direction of the light emitting diodes (LEDs) on the first supporting surfaces 1600 and the normal direction of the end surface of the base unit “M”, and the acute angle is indicated by the included angle “A”. The acute angle “A” is in a range between 5 degrees to 15 degrees. An acute angle is formed by the light emission direction of the light emitting diode (LEDs) on the second supporting surfaces 1601 and the normal direction of the end surface of the base unit “M”, and the acute angle is indicated by the included angle “B”. The acute angle “B” is in a range between 35 degrees to 40 degrees. An acute angle is formed by the light emission direction of the light emitting diode (LEDs) on the edge supporting surface 1602 and the normal direction of the end surface of the base unit “M”, and the acute angle is indicated by the included angle “C”. The acute angle “C” is in a range between 45 degrees to 60 degrees. In the embodiment, the acute angle “A” is 9 degrees, the acute angle “B” is 36 degrees, and the acute angle “C” is 48 degrees. A plurality of first connected parts 1603 are configured between the first supporting surfaces 1600 and the second supporting surfaces 1601 to connect the first supporting surfaces 1600 and the second supporting surfaces 1601. A plurality of second connected parts 1604 are configured between the second supporting surfaces 1601 and the edge supporting surface 1602 to connect the second supporting surfaces 1601 and the edge supporting surface 1602. Furthermore, the lower body frame 1 includes a power groove 10 and a fixed part 11. The power groove 10 is used for placing the power supply of the high-power light emitting diode (LED) street lamp 8. The fixed part 11 is used for fixing the lower body frame 1 and for fixing the high-power light emitting diode (LED) street lamp 8 to the object, such as a railing of street lamp.

A surface shape of the reflecting device 4 contacting with the base unit 160 corresponds to the shape of the base unit 160. A plurality of through-holes are configured on the reflecting device 4 where the through-holes correspond to the light emitting diode (LED) lens device 3. The through-holes are passed through by the light emitting diode (LED) lens device 3. There is a reflection film on the reflecting device 4 and the reflection plane of the reflecting device 4 is a reflecting surface to diffuse the light.

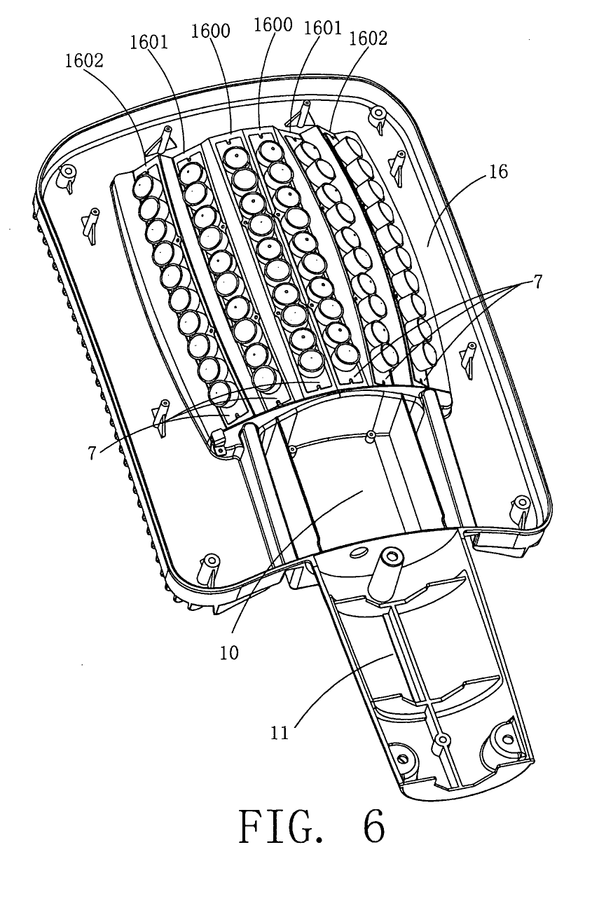

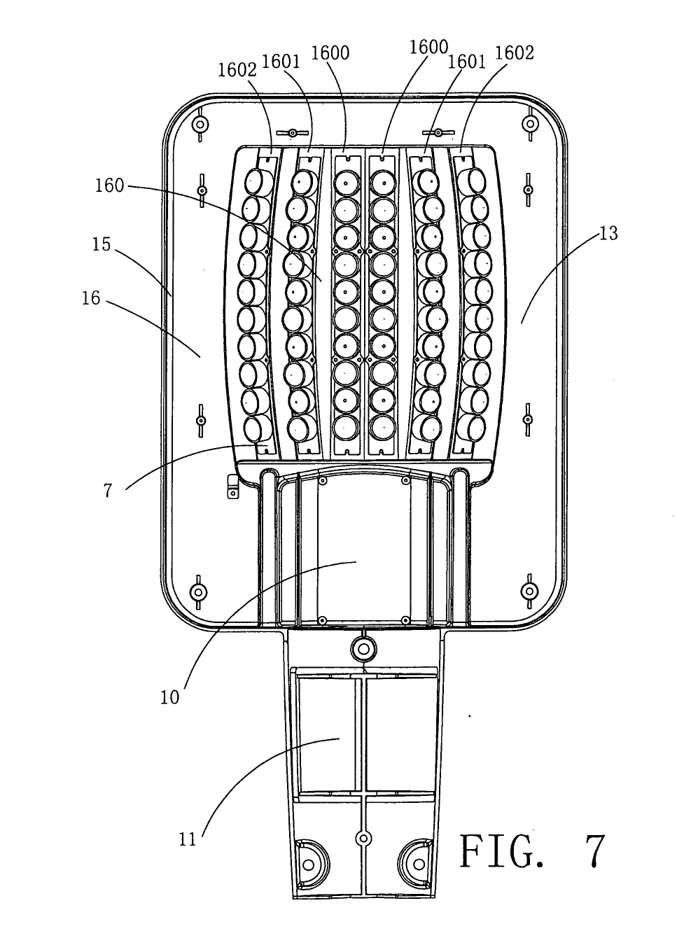

Please refer to FIG. 6 and FIG. 7. The circuit board 2 is made up of thermal conductive material, such as an aluminum circuit board. The light emitting diodes (LEDs) are configured adjacently on the surface of the base unit 160 through the circuit board 2. The configuration of the light emitting diodes (LEDs) on the circuit boards 2 is shown in FIG. 6. A spatial location relation of a whole light emitting diode (LED) structure formed by the light emitting diode (LED) modules 7 on the base unit 160 corresponds to a spatial location relation formed by the supporting surfaces (1600, 1601, and 1602) of the base unit 160. Furthermore, thermal conductive adhesive (not shown) is configured between the circuit board 2 and the base unit 160. Thermal conductive adhesive is used for conducting the heat away from the light emitting diode (LED) modules 7 to achieve better cooling effects.

The feature of the present invention ensures that while the angle formed by the light emission direction of the light emitting diodes (LEDs) on the edge supporting surfaces 1602 and the normal direction of the end surface of the base unit is in a range between 45 degrees to 60 degrees, the light emitting diode (LED) modules 7 in the high-power light emitting diode (LED) street lamp 8 are convexly positioned along the light emission direction of the high-power light emitting diode (LED) street lamp 8. Thus, the various parameters of the high-power light emitting diode (LED) street lamp 8 achieve the requirements of road illumination more easily. The specific conformation of the first supporting surfaces 1600 and the second supporting surfaces 1601 could be used by various shapes as long as the first supporting surfaces 1600 and the second supporting surfaces 1601 are completely protruded outwardly. For example, the whole of the base unit 160 is outward protruded and arc-shaped configuration.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A high-power light emitting diode (LED) street lamp, comprising:
a body frame;
a plurality of light emitting diode (LED) modules having a plurality of light emitting diodes (LEDs), and at least one circuit board, wherein the light emitting diodes (LEDs) are electrically connected to the at least one circuit board; and
a base unit convexly positioned on the body frame along the light emission direction of the high-power light emitting diode (LED) street lamp, wherein the base unit has a plurality of supporting surfaces which support the light emitting diode (LED) modules, the supporting surfaces are symmetrically positioned on a normal direction of an end surface of the base unit, and the light emitting diode (LED) modules are positioned on the adjacent supporting surfaces, respectively;
wherein the supporting surfaces further comprise a plurality of edge supporting surfaces positioned on the edges of the base unit, and an angle formed by the light emission direction of the light emitting diodes (LEDs) on the edge supporting surfaces and the normal direction of the end surface of the base unit is in a range between 45 degrees to 60 degrees.

2. The high-power light emitting diode (LED) street lamp of claim 1, wherein the supporting surfaces of the base unit further comprise:
a plurality of first supporting surfaces adjacent to the normal direction of the end surface of the base unit, wherein an angle formed by the light emission direction of the light emitting diodes (LEDs) on the first supporting surfaces and the normal direction of the end surface of the base unit is in a range between 5 degrees to 15 degrees; and

3. The high-power light emitting diode (LED) street lamp of claim 2, further comprising a plurality of second supporting surfaces adjacent to the first supporting surfaces, wherein one side of the second supporting surfaces is next to the first supporting surfaces, and the other side is next to the edge supporting surfaces; an angle formed by the light emission direction of the light emitting diodes (LEDs) on the second supporting surfaces and the normal direction of the end surface of the base unit is in a range between 35 degrees to 40 degrees.

4. The high-power light emitting diode (LED) street lamp of claim 3, wherein the angle formed by the light emission direction of the light emitting diodes (LEDs) on the edge supporting surfaces and the normal direction of the end surface of the base unit is 48 degrees; the angle formed by the light emission direction of the light emitting diodes (LEDs) on the first supporting surfaces and the normal direction of the end surface of the base unit is 9 degrees; the angle formed by the light emission direction of the light emitting diodes (LEDs) on the second supporting surfaces and the normal direction of the end surface center of the base unit is 36 degrees.

5. The high-power light emitting diode (LED) street lamp of claim 2, wherein the first supporting surfaces are planar shape, and the second supporting surfaces and the edge supporting surfaces are outward protruded and arc-shaped configurations.

6. The high-power light emitting diode (LED) street lamp of claim 1, wherein a spatial location relation of a whole light emitting diode (LED) structure formed by the light emitting diode (LED) modules on the base unit corresponds to a spatial location relation formed by the supporting surfaces of the base unit.

7. The high-power light emitting diode (LED) street lamp of claim 1, wherein the base unit and the body frame are integrated into one-piece by protruding the base unit from a bottom wall of the body frame upwardly, and a plurality of heat sinks are positioned on the other side of the base unit and extend from the bottom wall of the body frame to an opposite direction of the base unit which protrudes from the bottom wall of the body frame.

8. A body frame of a high-power light emitting diode (LED) street lamp, comprising a base unit convexly positioned on the body frame along the light emission direction of the high-power light emitting diode (LED) street lamp, wherein the base unit has a plurality of supporting surfaces for supporting a plurality of light emitting diode (LED) modules, the supporting surfaces are symmetrically positioned on a normal direction of an end surface of the base unit, and the light emitting diode (LED) modules are positioned on the adjacent supporting surfaces, respectively;
wherein the supporting surfaces further comprise a plurality of edge supporting surfaces positioned on the edges of the base unit, and an angle formed by the light emission of the light emitting diode (LED) modules on the edge supporting surfaces and the normal direction of the end surface of the base unit is in a range between 45 degrees to 60 degrees.

9. The body frame of the high-power light emitting diode (LED) street lamp of claim 8, wherein the supporting surfaces further comprise a plurality of first supporting surfaces adjacent to the normal direction of the end surface of the base unit, and wherein an angle formed by the light emission direction of the light emitting diode (LED) modules on the first supporting surfaces and the normal direction of the end surface of the base unit is in a range between 5 degrees to 15 degrees.

10. The body frame of the high-power light emitting diode (LED) street lamp of claim 9, further comprising a plurality of second supporting surfaces adjacent to the first supporting surfaces;
wherein one side of the second supporting surfaces is next to the first supporting surfaces, the other side is next to the edge supporting surfaces, and an angle formed by the light emission direction of the light emitting diode (LED) modules on the second supporting surfaces and the normal direction of the end surface of the base unit is in a range between 35 degrees to 40 degrees.
